(19) United States
(12) Patent Application Publication
(10) Pub. No.: US 2016/0252905 A1
(43) Pub. Date: Sep. 1, 2016

(54) REAL-TIME ACTIVE EMERGENCY VEHICLE DETECTION

(71) Applicant: Google Inc., Mountain View, CA (US)

(72) Inventors: Yuandong Tian, Sunnyvale, CA (US); Wan-Yen Lo, Sunnyvale, CA (US); David Ian Franklin Ferguson, San Francisco, CA (US)

(21) Appl. No.: 14/471,640

(22) Filed: Aug. 28, 2014

(51) Int. Cl. G05D 1/00

(52) U.S. Cl. CPC G05D 1/0088; G05D 2201/0212

(57) ABSTRACT

A system and method is provided for detecting and responding to emergency vehicles. In one aspect, one or more computing devices may identify a set of light sources from an image based at least in part on one or more templates, and may filter the set of light sources in order to identify one or more light sources corresponding to a potential emergency vehicle. Moreover, the one or more computing devices may determine whether any of the one or more light sources is flashing and whether any of the one or more light sources is associated with a particular type of the potential emergency vehicle. Further, the one or more computing devices may maneuver a vehicle based on the determination to yield in response to at least one of the one or more flashing light sources and the particular type of the emergency vehicle.

### BACKGROUND

Autonomous vehicles, such as vehicles which do not require a human driver, may be used to aid in the transport of passengers or items from one location to another. An important component of an autonomous vehicle is the perception system, which allows the vehicle to perceive and interpret its surroundings using cameras, radar, sensors, and other similar devices. The perception system executes numerous decisions while the autonomous vehicle is in motion, such as speeding up, slowing down, stopping, turning, etc. Autonomous vehicles may also use the cameras, sensors, and global positioning devices to gather and interpret images and sensor data about its surrounding environment, e.g., oncoming vehicles, parked cars, trees, buildings, etc. For example, an approaching emergency vehicle, such as a police car, having engaged its flashing lights may need to be given priority and right-of-way on the road. Thus, an autonomous vehicle may need to accurately detect and properly respond to approaching emergency vehicles.

### BRIEF SUMMARY

In one aspect, a method comprises identifying, using one or more computing devices, a set of light sources from an image based at least in part on one or more templates, and filtering, using the one or more computing devices, the set of light sources in order to identify one or more light sources corresponding to a potential emergency vehicle. Moreover, the method comprises determining, using the one or more computing devices, whether any of the one or more light sources is flashing, and determining, using the one or more computing devices, whether any of the one or more light sources is associated with a particular type of the potential emergency vehicle. Based on the determination, the method comprises maneuvering, using the one or more computing devices, a vehicle to yield in response to at least one of the one or more flashing light sources and the particular type of the emergency vehicle.

In another aspect, a system is provided comprising a memory and one or more computing devices, each of the one or more computing devices having one or more processors, the one or more computing devices being coupled to the memory. The one or more computing devices are configured to identify a set of light sources from an image based at least in part on one or more templates, and filter the set of light sources in order to identify one or more light sources corresponding to a potential emergency vehicle. Moreover, the one or more computing devices are configured to determine whether any of the one or more light sources is flashing, and determine whether any of the one or more light sources is associated with a particular type of the potential emergency vehicle. Based on the determination, the one or more computing devices are configured to maneuver a vehicle to yield in response to at least one of the one or more flashing light source and the particular type of the emergency vehicle.

In yet another aspect, a non-transitory, tangible computer-readable medium on which instructions are stored, the instructions, when executed by one or more computing devices perform a method, the method comprises identifying a set of light sources from an image based at least in part on one or more templates, and filtering the set of light sources in order to identify one or more light sources corresponding to a potential emergency vehicle. Moreover, the method comprises determining whether any of the one or more light sources is flashing, and determining whether any of the one or more light sources is associated with a particular type of the potential emergency vehicle. Based on the determination, the method comprises maneuvering a vehicle to yield in response to at least one of the one or more flashing light source and the particular type of the emergency vehicle.

### BRIEF DESCRIPTION OF THE DRAWINGS

FIG. 1A is a functional diagram of a system in accordance with aspects of the disclosure.

FIG. 1B is an example illustration of the vehicle of FIG. 1A in accordance with aspects of the disclosure.

FIG. 2A is an example of one or more templates in accordance with aspects of the disclosure.

FIG. 2B is another example of one or more templates in accordance with aspects of the disclosure.

FIG. 3 is an example image captured by a camera in accordance with aspects of the disclosure.

FIG. 4A is an example image associated with emergency vehicle light detection in accordance with aspects of the disclosure.

FIG. 4B is another example image associated with emergency vehicle light detection in accordance with aspects of the disclosure.

FIG. 4C is a further example image associated with emergency vehicle light detection in accordance with aspects of the disclosure.

FIG. 5 is an example flow diagram in accordance with aspects of the disclosure.

### DETAILED DESCRIPTION

The present disclosure is directed to detecting and responding to emergency vehicles (EVs). For example, a perception system of an autonomous vehicle may capture images of its surrounding environment to detect and respond to an approaching EV. The captured images may be analyzed by one or more computing devices. The analysis may include detecting light in each of the captured images and determining whether the detected light is likely associated with an EV based on different templates. When detected light is likely associated with an EV, the one or more computing devices may determine whether the detected light is flashing. In this regard, the one or more computing devices may perform analyses on the light's spatial configuration and flash pattern to further determine whether the detected light corresponds to an EV. By doing so, the vehicle may properly identify and respond to EVs, such as by slowing down or pulling over.

In order to detect an EV, an autonomous vehicle may detect light sources being emitted near the autonomous vehicle using one or more cameras and various types of sensors. For example, a perception system of the autonomous vehicle may capture a plurality of images via one or more cameras. Moreover, the perception system may identify various objects via at least a laser-rangefinder. As such, the one or more computing devices vehicle may perform analysis on corresponding areas of the captured images and laser data to detect and respond to an approaching EV.

In one aspect, a cascaded light detection technique may be used to detect light sources from potential EVs in the captured image. For example, at least two detection stages may be used. A first detection stage may be fast and computationally cheap (e.g., low resource). A second detection stage may be more accurate than the first detection stage, but computationally expensive. During the first detection stage, the one or more computing devices may scan an entire image to rapidly identify at least all likely light sources and the colors associated therewith. During a second detection stage, the likely EV light sources may be further filtered to remove at least false positives, such as shading or sun glare.

Once light from a potential EV is detected, the one or more computing devices may determine whether that light is flashing. For example, a region where light is detected in one image may be compared to the same region in a previous image. The region may be an area around the detected light. When the light is detected in the region of the previous image, then the one or more computing devices may determine that the light is not flashing. When the light is not detected in the region of the previous image, the one or more computing device may analyze a series of image to determine whether the light is flashing.

When a flashing light is detected, the one or more computing devices may perform analysis on the light's spatial configuration and flash pattern to further determine whether the flashing light corresponds to a type of EV. For example, the one or more computing devices may determine that orange and blue flashing lights sitting together horizontally relate to a police vehicle (PV). Once the one or more computing devices determine that the flashing light corresponds to a particular type of EV, the autonomous vehicle may appropriately respond by slowing down and/or pulling over to the side of the road. When a flashing light is not detected, the autonomous vehicle may continue to operate in a normal mode.

In another aspect, flash classifiers may be trained to capture light and flash patterns for various EVs in order to improve EV detection and response. For example, numerous light configurations, flash patterns and sounds of PVs may be captured, analyzed and stored in one or more memory devices over time to be used in training a PV flash classifier. In this regard, the flash classifier may be another variable that can be used to more accurately detect and respond to an approaching EV.

The above-described features are related to the detection and analysis of light in a series of captured images. In that regard, an approaching EV may be quickly and efficiently detected regardless of the size and appearance of the EV.

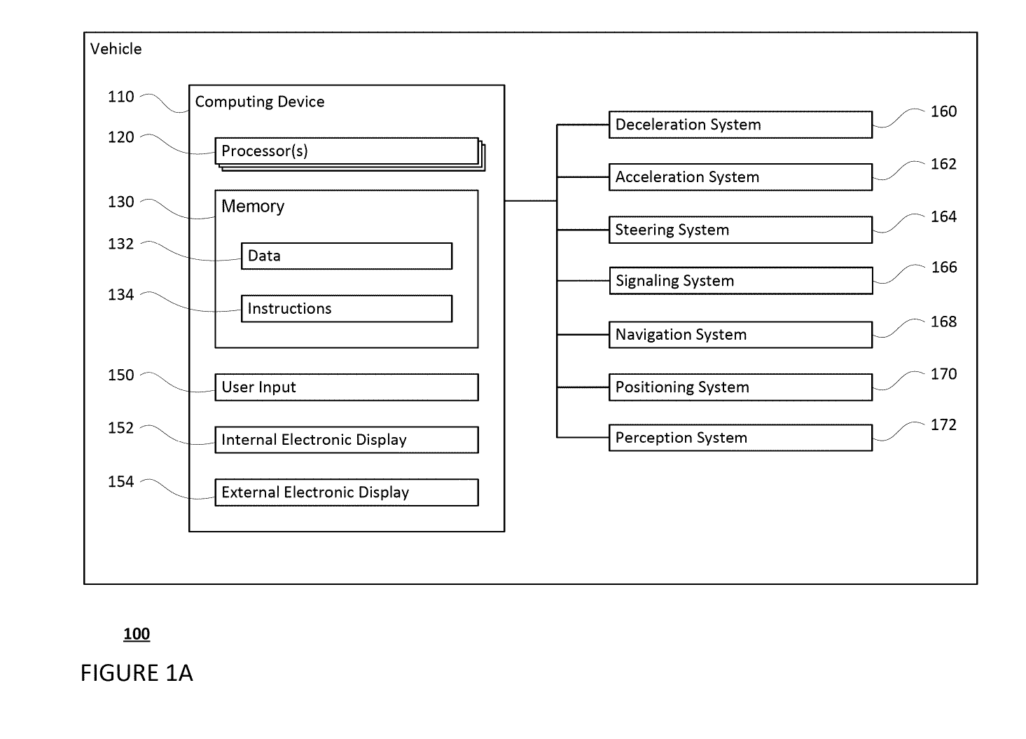

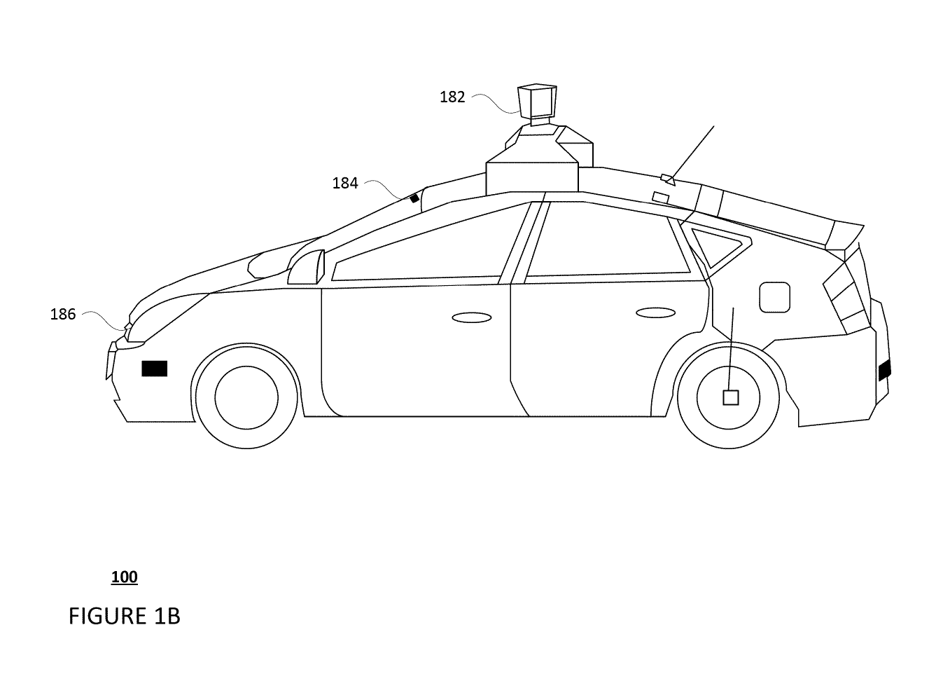

As shown in FIG. 1A, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, busses, boats, airplanes, helicopters, lawnmowers, recreational vehicles, amusement park vehicles, farm equipment, construction equipment, trams, golf carts, trains, and trolleys. The vehicle may have one or more computing devices, such as computing device 110 containing one or more processors 120, memory 130 and other components typically present in general purpose computing devices.

The memory 130 stores information accessible by the one or more processors 120, including data 132 and instructions 134 that may be executed or otherwise used by the processor(s) 120. The memory 130 may be of any type capable of storing information accessible by the processor(s), including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 132 may be retrieved, stored or modified by processor(s) 120 in accordance with the instructions 132. For instance, although the claimed subject matter is not limited by any particular data structure, the data may be stored in computing device registers, in a relational database as a table having a plurality of different fields and records, XML documents or flat files. The data may also be formatted in any computing device-readable format.

For example, data 132 may include one or more templates configured to detect light sources and colors thereof. The templates may be a light template, a color template, a combination of the light and color templates, or different types of image templates. For example, these templates may be used to detect light sources and whether the light sources are associated with EVs. As will be further discussed below, the one or more processors 120 of computing device 110 may use the one or more above-described templates and implement a cascaded light detection technique to identify light sources associated with EVs, and subsequently determine whether these light sources are flashing, determine the type of EV, and respond accordingly.

In another example, data 132 may also include a plurality of classifiers. One example of a classifier may be a flashing bar classifier. For instance, the flashing bar classifier may include numerous police vehicle (PV) light patterns and may be trained over time to more accurately detect different types of PVs. Other types of classifiers may be associated with ambulance light patterns, sound patterns, light configurations, etc. Further, the data 132 may also include information related to different types of EVs, e.g., types of vehicles, sizes, shapes, common sounds, flash patterns, light patterns, etc.

In a further example, data 132 may also include location information (e.g., GPS coordinates) associated with various light sources expected to be within or at a geographical area. For instance, a particular intersection may have a certain number of traffic lights, street lights, pedestrian crosswalk lights, etc. These light sources may be associated with geolocation data, such that the computing device 110 of vehicle 100 may be able to readily determine the quantity and, in some instances, the exact location of the light sources at the intersection. In this regard, the computing device 110 may be able to quickly and efficiently filter light sources that are not associated with EVs when determining whether any detected light sources likely correspond to EVs.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The one or more processors 120 may be any conventional processors, such as commercially available CPUs. Alternatively, the one or more processors may be a dedicated device such as an ASIC or other hardware-based processor, such as a field programmable gate array (FPGA). Although FIG. 1A functionally illustrates the processor(s), memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing device 110 may have all of the components normally used in connection with a computing device such as the processor and memory described above, as well as a user input 150 (e.g., a mouse, keyboard, touch screen and/or microphone) and various electronic displays (e.g., a monitor having a screen, a small LCD touch-screen or any other electrical device that is operable to display information). In this example, the vehicle includes an internal electronic display 152 as well as an external electronic display 154. In this regard, internal electronic display 152 may be located within a cabin of vehicle 100 and may be used by computing device 110 to provide information to passengers within the vehicle 100. External electronic display 154 may be located eternally or mounted on an external surface of the vehicle 100 and may be used by computing device 110 to provide information to potential passengers or other persons outside of vehicle 100.

In one example, computing device 110 may be an autonomous driving computing system incorporated into vehicle 100. The autonomous driving computing system may capable of communicating with various components of the vehicle. For example, returning to FIG. 1, computing device 110 may be in communication various systems of vehicle 100, such as deceleration system 160, acceleration system 162, steering system 164, signaling system 166, navigation system 168, positioning system 170, and perception system 172, such that one or more systems working together may control the movement, speed, direction, etc. of vehicle 100 in accordance with the instructions 134 stored in memory 130. Although these systems are shown as external to computing device 110, in actuality, these systems may also be incorporated into computing device 110, again as an autonomous driving computing system for controlling vehicle 100.

As an example, computing device 110 may interact with deceleration system 160 and acceleration system 162 in order to control the speed of the vehicle. Similarly, steering system 164 may be used by computing device 110 in order to control the direction of vehicle 100. For example, if vehicle 100 configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Navigation system 168 may be used by computing device 110 in order to determine and follow a route to a location. In this regard, the navigation system 168 and/or data 132 may store map information, e.g., highly detailed maps identifying the shape and elevation of roadways, lane lines, intersections, crosswalks, speed limits, traffic signals, buildings, signs, real time traffic information, vegetation, or other such objects and information.

Positioning system 170 may be used by computing device 110 in order to determine the vehicle's relative or absolute position on a map or on the earth. For example, the position system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The positioning system 170 may also include other devices in communication with computing device 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 172 also includes one or more components for detecting and performing analysis on objects external to the vehicle such as other vehicles, obstacles in the roadway, traffic signals, signs, trees, etc. For example, the perception system 172 may include lasers, sonar, radar, one or more cameras, or any other detection devices which record data which may be processed by computing device 110. In the case where the vehicle is a small passenger vehicle such as a car, the car may include a laser mounted on the roof or other convenient location.

The computing device 110 may control the direction and speed of the vehicle by controlling various components. By way of example, if the vehicle is operating completely autonomously, computing device 110 may navigate the vehicle to a location using data from the detailed map information and navigation system 168. Computing device 110 may use the positioning system 170 to determine the vehicle's location and perception system 172 to detect and respond to objects when needed to reach the location safely. In order to do so, computing device 110 may cause the vehicle to accelerate (e.g., by increasing fuel or other energy provided to the engine by acceleration system 162), decelerate (e.g., by decreasing the fuel supplied to the engine or by applying brakes by deceleration system 160), change direction (e.g., by turning the front or rear wheels of vehicle 100 by steering system 164), and signal such changes (e.g. by lighting turn signals of signaling system 166).

FIG. 1B is an example illustration of vehicle 100 described above. As shown, various components of the perception system 172 may be positioned on the roof of vehicle 100 in order to better detect external objects while the vehicle is engaged. In this regard, one or more sensors, such as laser range finder 182 may be positioned or mounted to the roof of vehicle 101. Thus, the computing device 110 (not shown) may control laser range finder 182, e.g., by rotating it 180 degrees, or one or more cameras 184 mounted internally on the windshield of vehicle 100 to receive and analyze various images about the environment. Although the laser range finder 182 is positioned on top of perception system 172 in FIG. 1B, and the one or more cameras 184 mounted internally on the windshield, other detection devices, such as sonar, radar, GPS, etc., may also be positioned in a similar manner.

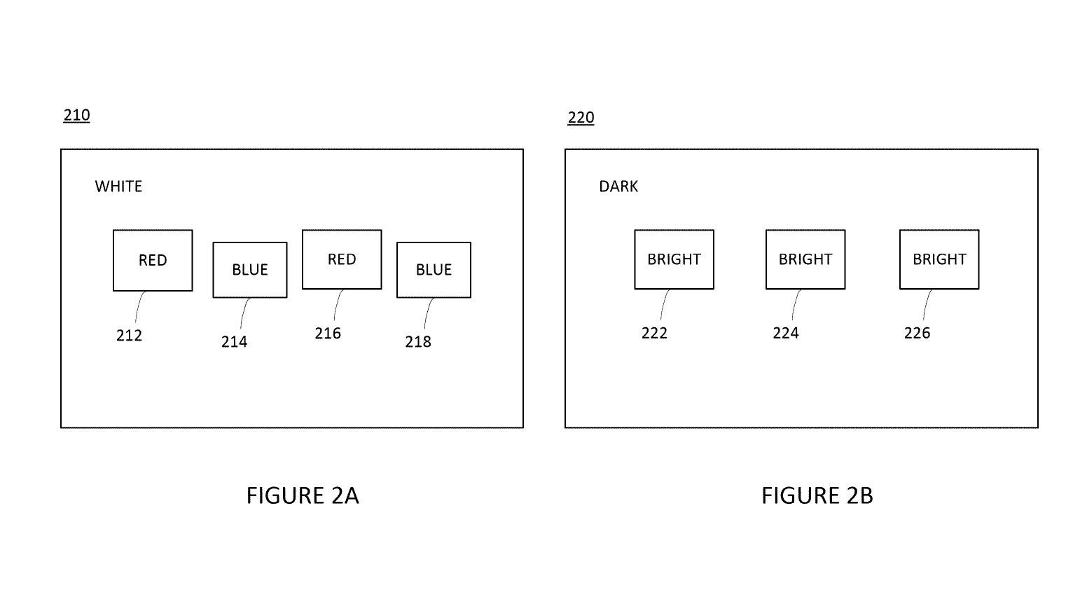

As described above, one or more templates may be stored in memory 130 of computing device 110. FIGS. 2A-B depict example applications of one or more templates that may be used to detect light sources and determine whether the detected light sources correspond to EVs. As shown, templates 212, 214, 216, 218 may be based on at least light color to identify potential EVs in image 210. Templates 222, 224, 226 may be based on at least brightness to identify potential EVs in image 220. The one or more templates may also be based on light color, brightness, or combinations of other types of characteristics, etc. After one or more potential light sources corresponding to EVs are identified in an image, the spatial configuration of the individual light sources, size of the light sources, etc., may be used to determine the type of EV. In one example, the templates 212, 214, 216, 218, 222, 224, and 226 may be applied to a particular area of the images 210 and 220 captured by the one or more cameras 184 of vehicle 100, or in other scenarios, the templates may be applied to the entire image. For instance, the particular area of the image that a template may correspond to could be a bounding box of an object (e.g., a vehicle) generated by the laser rangefinder 182 of vehicle 100.

In addition to the operations described above and illustrated in the figures, various operations will now be described. It should be understood that the following operations do not have to be performed in the precise order described below. Rather, various steps can be handled in a different order or simultaneously, and steps may also be added or omitted.

In one aspect, the one or more templates stored in memory 130 may be used to convert an image captured by the one or more cameras 184 into a customized color-space so that certain colors (e.g., orange, yellow, blue, red, etc.) may become conspicuous. For example, a template may be applied to an image, such that the template may convert a traditional red-green-blue (RGB) color-space into a “max-R,” “max-B,” and “mean-RGB” color-space. For example, “max-R” and “max-B” may be defined as maximizing only the red and blue colors, respectively, and any color in the image that is not red or blue may be blended to a generally white color via the “mean-RGB” function. In this regard, any light that is either red or blue can be easily identified based on the applied template.

FIG. 2A illustrates one or more example templates 212, 214, 216, 218 corresponding to various areas of image 210, which may be used to identify light sources in the image associated with a police vehicle (PV). In this example, the templates 212, 214, 216, and 218 may be applied to a particular area of the image 210, such as a bounding box corresponding to a vehicle. As shown, each template identifies four different light sources in a generally horizontal configuration within particular areas in image 210. The templates 212, 214, 216, and 218 may also indicate that the four light sources are emitting a red light, a blue light, another red light, and another blue light, respectively. The four light sources may be surrounded by a generally white color, e.g., mixture of the red, green, and blue light associated with a RGB color-space. In this regard, using this information derived from the templates, the computing device 110 of vehicle 100 may determine that the light sources may likely be associated with a PV based on at least the color of the lights and the spatial configuration of the four different light sources.

FIG. 2B illustrates one or more example templates 222, 224, 226 corresponding to various areas of image 220, which may be used to identify light sources in the image associated with an ambulance. Similar to the one or more templates 212, 214, 216, and 218, the one or more templates 222, 224, 226 may also be applied to particular areas of the image 220. Again, the particular area may be a bounding box corresponding to a vehicle. As depicted, each template identifies three specific bright regions of the image 220 surrounded by a generally dark region. Thus, the computing device 110 may determine that these bright areas may likely be associated with light sources. Further, the computing device 110 may identify that the light sources may likely correspond to an ambulance based on at least the spatial configuration of the bright areas.

While FIGS. 2A-B depict one or more templates based on color and brightness, respectively, an individual template may also be based on both color and brightness. And as discussed above, the templates are not limited thereto.

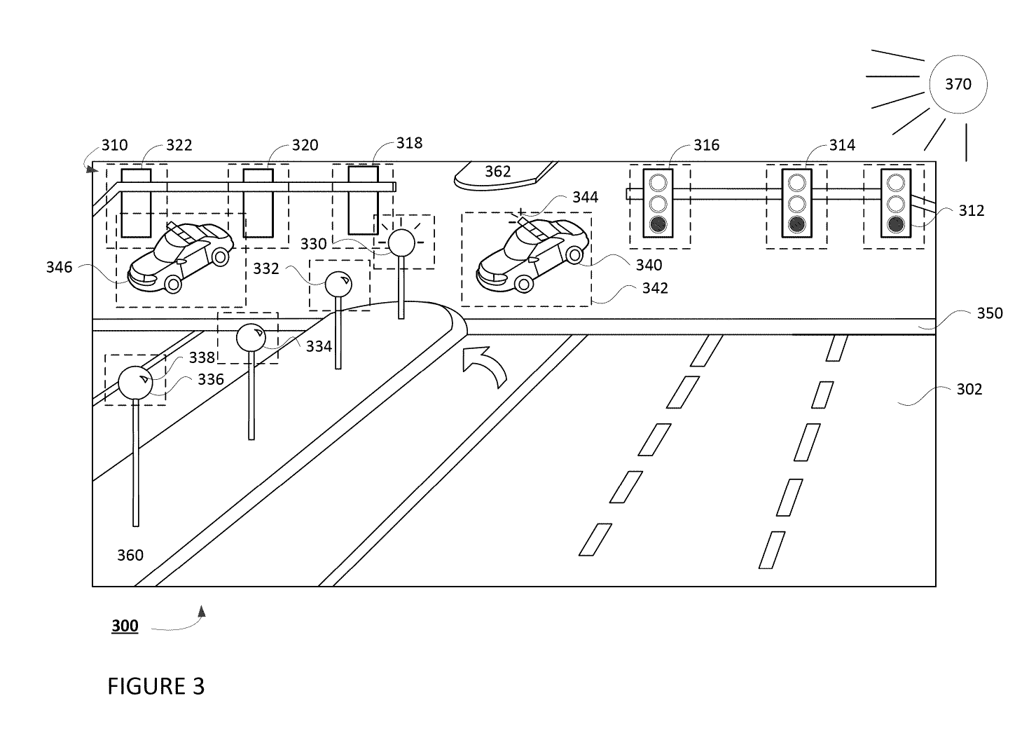

A vehicle may be traveling along a particular path and the perception system may be capturing images and gathering laser data of the vehicle's surrounding environment. FIG. 3 is an example image 300 captured by one or more cameras of the perception system. In this example, autonomous vehicle 100 may be traveling along road 302 and simultaneously capturing numerous images of the vehicle 100's surrounding environment. As the vehicle 100 approaches intersection 310 along road 302, the one or more cameras 184 may capture the image 300 of at least the intersection 310.

The image 300 includes various objects. For instance, the intersection 310 includes traffic lights 312, 314, 316, 318, 320, 322, streetlights 330, 332, 334, 336, a pedestrian crosswalk 350 perpendicular to the road 302, medians 360 and 362, etc. The image 300 may also include police vehicles (PVs) 340, 346.

The perception system 172 may identify objects based on laser data collected from the laser rangefinder 182 of vehicle 100. For each identified object, the perception system 172 may determine a bounding box for the laser data corresponding to that object. Thus, each bounding box has a 3D geometry that includes a 3D location. This 3D location may be used to identify the locations of corresponding objects in image 300 using known techniques for detecting locations in images. The 2D locations of these bounding boxes are graphically in image 300 represented by dashed boxes, e.g., dashed box 342 around PV 340.

The templates may be applied to an entire image or individual dashed boxes corresponding to an object. By doing so, the computing device 110 of the vehicle 100 may be configured to identify all light sources in the one or more captured images. From this set of identified light sources, the computing device may determine which lights sources (if any) within the set most likely correspond to EVs using a cascaded light detection technique including multiple detection stages.

During a first detection stage, the computing device 110 may quickly analyze all the objects in the image 300 and ultimately identify that light is being emitted from traffic lights 312, 314, 316, streetlights 330, 332, 334, 336, and PV 340 based on the one or more templates stored in the memory 130. Subsequently, during a second detection stage, the computing device 110 may more accurately determine whether any of the identified light sources correspond to the characteristics of an EV.

As noted above, during the first detection stage, the computing device 110 may quickly scan the entire image 300 and identify potential light sources. The first detection stage may be a fast, a computationally cheap, and/or a low resource-consuming technique. For instance, the first detection stage may generally look for the epicenter of the light sources, e.g., the brightest areas of the image 300. In another instance but not limited thereto, the first detection stage may identify the brightest area of the image, local areas of the image that contain a bright spot surrounded by the dark regions, etc.

Because the first detection stage attempts to quickly identify only the bright areas of the image 300, light sources either unrelated to EVs or false positives, such as glare from sun 370, may be included in the identified set of light sources. For example, using templates 210 or 220, or a combination thereof, the computing device 110 may rapidly identify that the traffic lights 312, 314, 316, the streetlights 330, 332, 334, 336, and PV 340 are all light sources. As illustrated, however, only streetlight 330 is emitting light. Streetlights 332, 334, and 336 are reflecting light from the sun 370. Further, the computing device 110 may identify only the light being emitted from traffic lights 312, 314, 316, and not traffic lights 318, 320, and 322 since they face-away from the one or more cameras 184.

In order to remove any false positives and filter out potential light sources that may be unrelated to EVs, the second detection stage may be used. The second detection stage may more accurately analyze a larger area around an epicenter of the identified light source and analyze associated colors to determine whether the light source corresponds to a potential EV. For example, a sun glare on a streetlight may have a brightness concentrated at the epicenter of the identified light source. Based on at least this characteristic of the sun glare, a computing device may filter out the sun glare. The filtering may be performed during the second detection stage.

A light source truly emitting light may exhibit gradually decreasing brightness levels from the epicenter of the light source. In addition, the colors of the lights may also be analyzed to further determine whether the light source is originating from an EV. In that regard, the one or more computing device may more accurately include the light sources that correspond to EVs during the second detection stage by using various filtering techniques.

In one example, light sources that exhibit certain characteristics associated with false positives may be excluded from the identified set of light sources. For example, during the second light detection stage, the computing device 110 may filter out any false positives, such as streetlights 332, 334 and 336. Unlike streetlight 330, the streetlights 332, 334 and 336 are turned-off and reflect sunlight from the sun 370 in the form of glare, e.g., glare 336. As noted above, these glares may have been identified in the first detection stage.

In another example, light sources that exhibit color(s) that may be unrelated to colors associated with EV light sources may be excluded from the identified set of light sources. For instance, while streetlight 330 is actually emitting light, it may be emitting white light. In this regard, the computing device 110 may filter streetlight 330 from the identified light sources based on the color of the light and because the color is unrelated to colors of light associated with EVs, e.g., red, blue, etc.

In a further example, light sources that may be known to be unassociated with EVs based on geographical location data may be excluded from the set of the identified light sources. By way of example only, the computing device 110 may access information stored in memory 130 and determine that there are six traffic lights located at the intersection 310 based on the accessed information. The information may be at least geographical location data corresponding to the traffic lights. In other instances, the information may be static map information that may have been previously collected and stored. Based on this determination, the computing device 110 may exclude the traffic lights from the set of the identified light sources.

In other examples, light sources that exhibit characteristics associated with potential EVs may be identified to be further analyzed for flashing lights and to determine the type of EV. The computing device 110 may determine that light 344 emitted from PV 340 and the corresponding colors of light 344 are associated with the characteristics of an EV, particularly a PV. The color of light 344 may be red and blue. Further, the horizontal configuration of the light 344 may also indicate that the light may be associated with a PV.

The one or more computing devices of an autonomous vehicle may also determine whether light from the filtered light sources is flashing, e.g., whether the EV is involved in an emergency situation. For example, by analyzing multiple images, the computing device 110 may determine whether a light source corresponding to a potential EV is flashing. In that regard, a particular region of one image may be compared to the same region in a previous image. When the light source is emitting light in both images, the computing device 110 may determine that the light source is not flashing. In that regard, an on-off-on-off pattern among a series of images may indicate that the light source is flashing.

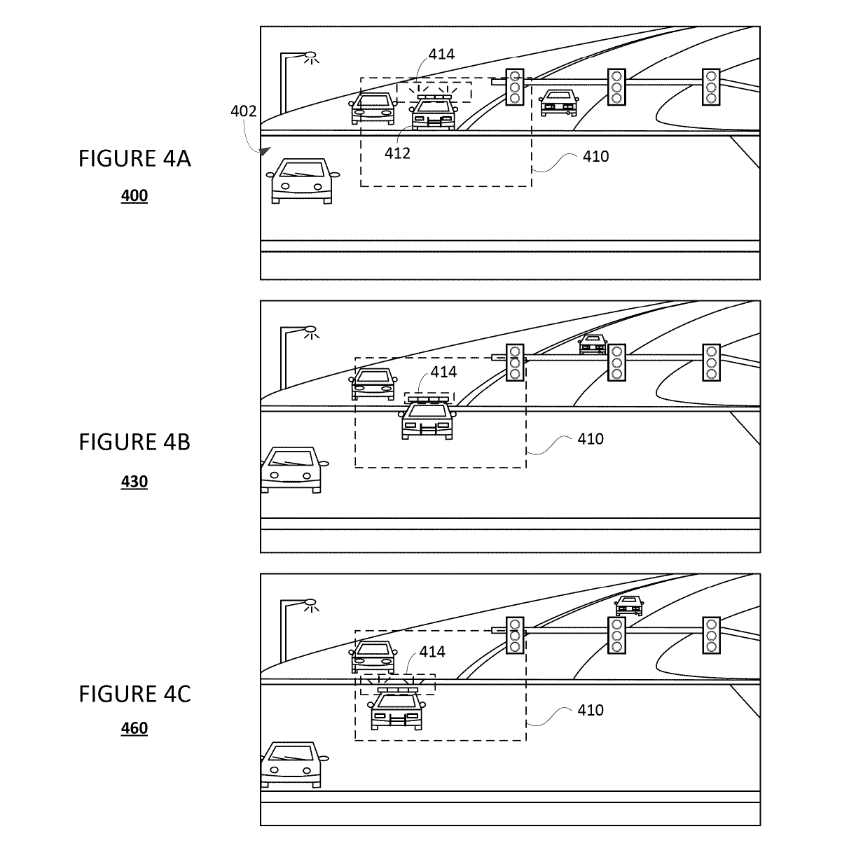

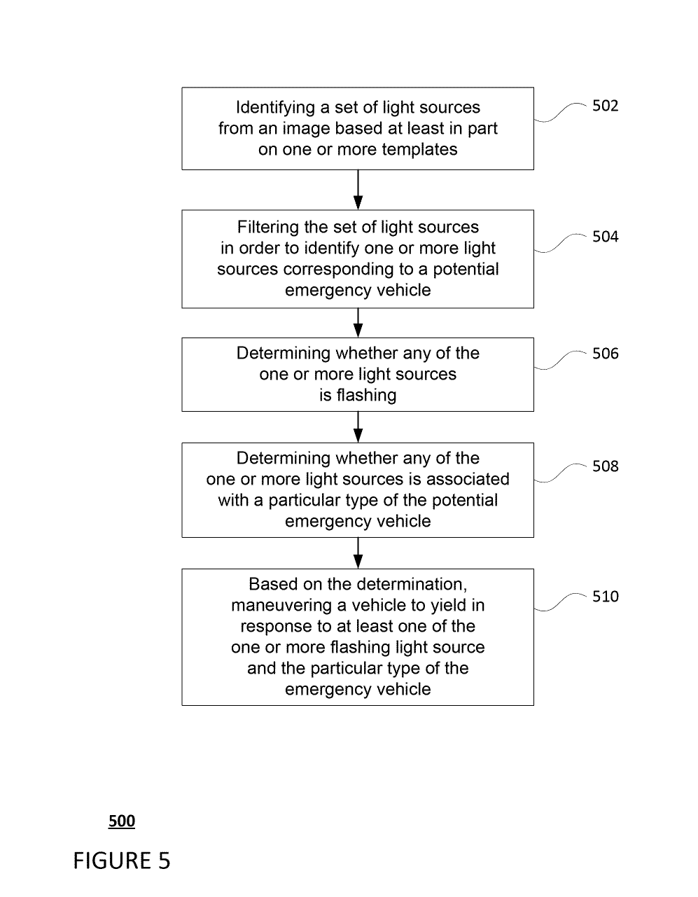

For example, FIGS. 4A-C depict three consecutive images (or frames) of the same intersection captured by the one or more cameras 184 of vehicle 100. FIG. 4A is an example image 400 of an intersection 402. In the image 400, an EV is approaching vehicle 100. The computing device 110 may have determined that light source 414 associated with object 412 corresponds to a potential EV based on the application of the first and second detection stages described above. In order to determine whether the light source 414 is flashing, an area corresponding to region 410 within other images may be analyzed. In this regard, the computing device 110 may analyze the same region 410 in a subsequent captured image and determine whether the light source 414 is still emitting light.

FIG. 4B is another example image 430 of the intersection 402 that the camera 184 captures after image 400. The computing device 110 again focuses on the region 410 to determine whether the light source 414 is still emitting light. As shown, the light source 414 is not emitting light within region 410. Thus, at this point of analysis, the light source 414 is exhibiting an on-off pattern. However, the computing device 110 may need to analyze at least one more image to determine whether the light source 414 is flashing.

FIG. 4C is yet another example image 460 of the intersection 402 that the camera 184 of vehicle 100 captures subsequent to image 430. In this example, the object 412 shifts to the bottom left corner of the region 410 and has moved closer to the one or more cameras 184 compared to image 430. In addition, the light source 414 is again emitting light. In that regard, the computing device 110 may determine that the on-off-on pattern among images 400, 430, and 460 indicates that the light source 414 is flashing. In an alternative example, if the computing device determines that light is still being emitted, the computing device may determine that the light source 414 is not flashing.

FIGS. 4A-C depict three images of the same intersection 402 that are used to determine whether the light source 414 is flashing, though more or less images may be used in other flash detection scenarios.

Once light sources corresponding to a potential EV are determined to be flashing, the computing device 110 may consider other factors before responding to the potential EV, such as the spatial configuration of such light sources. For example, the light source 414 in FIGS. 4A-C are configured in a generally horizontal manner. Based on the spatial configuration of the light source 414 and/or the comparison between the flash pattern of the light source 414 with one or more classifiers stored in memory 130, the computing device 110 may determine that the object 412 is a police vehicle (PV). Upon determining that the flashing light source corresponds to a PV, the autonomous vehicle may appropriately respond by slowing down and/or pulling over to the side of the road.

FIG. 5 is a flow diagram 500 in accordance with aspects of the disclosure. By way of example only, one or more computing devices, such as the computing device 110 of vehicle 100, may identify a set of light sources from an image based at least in part on one or more templates, at block 502. As described above, the one or more templates may be based on color, brightness, or a combination thereof. The identification of the set of light sources at block 502 may be performed during a first detection stage, which allows the computing device 110 to rapidly identify potential light sources in the image. During the first detection stage, potential light sources that do not correspond to EVs may be identified (e.g., false positives), and thus, the identified light sources may be filtered.

At block 504, the computing device 110 may filter the set of light sources in order to identify one or more light sources corresponding to a potential EV. In one example, false positives such as sun glare may be filtered out. In another example, light sources associated with colors that are unrelated to an EV may also be filtered out. In yet a further example, light sources that may be known to be unassociated with an EV based on geographical location data may be filtered out. Upon filtering the identified set of light sources at block 502, the computing device 110 may determine whether any of the one or more light sources is flashing, at block 506. As discussed above, whether the one or more light sources are flashing may be based on the analysis of multiple images.

At block 508, the computing device 110 may determine whether any of the one or more light sources is associated with a particular type of the potential EV. The type of EV may be determined based on at least the spatial configuration of the light sources and/or the flash pattern of the light sources. Based on the determination, the computing device 110 may maneuver a vehicle to yield in response to at least one of the one or more flashing light sources and the particular type of the emergency vehicle. For instance, if the computing device 110 determines that an approaching EV is a PV, it may yield to the PV by pulling over to a side of a road.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method comprising:
identifying, using one or more computing devices, a set of light sources from an image based at least in part on one or more templates;
filtering, using the one or more computing devices, the set of light sources in order to identify two or more light sources corresponding to a given potential emergency vehicle;
determining, using the one or more computing devices, that the two or more light sources is flashing;
determining, using the one or more computing devices, that the two or more light sources are associated with a particular type of the emergency vehicle by analyzing a relative spatial configuration of the two or more light sources and the determination that the two or more light sources are flashing; and
based on the determination that the two or more light sources are associated with the particular type of the emergency vehicle, maneuvering, using the one or more computing devices, a vehicle to yield in response to the given potential emergency vehicle.

2. (canceled)

3. The method of claim 1, wherein determining that the two or more light sources are associated with the particular type of emergency vehicle includes at least analyzing a flash pattern of the two or more light sources and comparing the flash pattern to one or more classifiers.

4. The method of claim 1, wherein filtering the set of light sources includes discarding light sources exhibiting one or more characteristics associated with a false positive for sun glare.

5. The method of claim 1, wherein filtering the set of light sources includes discarding light sources exhibiting one or more colors unrelated to colors associated with emergency vehicles.

6. The method of claim 1, wherein filtering the set of light sources includes discarding light sources unassociated with potential emergency vehicles based on at least geographical location data.

7. The method of claim 1, wherein filtering the set of light sources includes including light sources exhibiting one or more characteristics associated with potential emergency vehicles.

8. A system comprising:
a memory;
one or more computing devices, each of the one or more computing devices having one or more processors, the one or more computing devices being coupled to the memory;
wherein the one or more computing devices are configured to:
identify a set of light sources from an image based at least in part on one or more templates;
filter the set of light sources in order to identify two or more light sources corresponding to a given potential emergency vehicle;
determine that the two or more light sources are flashing;
determine that the two or more light sources are associated with a particular type of the emergency vehicle by analyzing a relative spatial configuration of the two or more light sources with respect to the potential emergency vehicle and the determination that the two or more light sources are flashing; and
based on the determination that the two or more light sources are associated with the particular type of the emergency vehicle, maneuver a vehicle to yield in response to the given potential emergency vehicle.

9. (canceled)

10. The system of claim 8, wherein the determination that the two or more light sources are associated with the particular type of emergency vehicle includes at least analysis of a flash pattern of the two or more light sources and comparison of the flash pattern to one or more classifiers.

11. The system of claim 8, wherein the filtration of the set of light sources includes discarding light sources exhibiting one or more characteristics associated with a false positive for sun glare.

12. The system of claim 8, wherein the filtration of the set of light sources includes discarding light sources exhibiting one or more colors unrelated to colors associated with emergency vehicles.

13. The system of claim 8, wherein the filtration of the set of light sources includes discarding light sources unassociated with potential emergency vehicles based on at least geographical location data.

14. The system of claim 8, wherein the filtration of the set of light sources includes including light sources exhibiting one or more characteristics associated with potential emergency vehicles.

15. A non-transitory, tangible computer-readable medium on which instructions are stored, the instructions, when executed by one or more computing devices perform a method, the method comprising:
identifying a set of light sources from an image based at least in part on one or more templates;
filtering the set of light sources in order to identify two or more light sources corresponding to a given potential emergency vehicle;
determining that the two or more light sources is flashing;
determining that the two or more light sources is associated with a particular type of the emergency vehicle by analyzing a spatial configuration of the two or more light sources with respect to the potential emergency vehicle and the determination that the two or more light sources are flashing; and
based on the determination that the two or more light sources is associated with the particular type of the emergency vehicle, maneuvering a vehicle to yield in response to the given particular emergency vehicle.

16. (canceled)

17. The non-transitory, tangible computer-readable medium of claim 15, wherein determining whether two or more light sources are associated with the particular type of the emergency vehicle includes at least analyzing a flash pattern of the one or more flashing light sources and comparing the flash pattern to one or more classifiers.

18. The non-transitory, tangible computer-readable medium of claim 15, wherein filtering the set of light sources includes discarding light sources exhibiting one or more characteristics associated with a false positive for sun glare.

19. The non-transitory, tangible computer-readable medium of claim 15, wherein filtering the set of light sources includes discarding light sources exhibiting one or more colors unrelated to colors associated with potential emergency vehicles.

20. The non-transitory, tangible computer-readable medium of claim 15, wherein filtering the set of light sources includes discarding light sources unassociated with potential emergency vehicles based on at least geographical location data.

21. The method of claim 1, wherein identifying the set of light sources from the image based at least in part on one or more templates includes:
using a first template including areas corresponding to a specific arrangement of colors of light to identify at least some light sources of the set of light sources; and
using a first template including areas corresponding to a specific arrangement of brightness regions to identify at least some light sources of the set of light sources.

22. The method of claim 1, wherein identifying the set of light sources from the image based at least in part on one or more templates includes using a template to convert the image to a customized color space so that a pre-defined set of colors are depicted in the customized color space.

23. The method of claim 22, wherein the customized color space consists of a maximum red value, a maximum blue value, and a third non red or blue value.
